(19) United States
(12) Patent Application Publication
(10) Pub. No.: US 2021/0191416 A1
(43) Pub. Date: Jun. 24, 2021

(54) AUTOMATIC GUIDED VEHICLE POSITIONING SYSTEM AND OPERATING METHOD THEREOF

(71) Applicant: INDUSTRIAL TECHNOLOGY RESEARCH INSTITUTE, Hsinchu (TW)

(72) Inventors: Cheng-You CHIANG, Taoyuan City (TW); Yong-Ren LI, Taichung City (TW); Chao-Hui TU, Taoyuan City (TW); Ching-Tsung CHENG, New Taipei City (TW)

(73) Assignee: INDUSTRIAL TECHNOLOGY RESEARCH INSTITUTE, Hsinchu (TW)

(21) Appl. No.: 16/721,439

(22) Filed: Dec. 19, 2019

(51) Int. Cl. G05D 1/02; G01C 21/20; G06K 7/14

(52) U.S. Cl. CPC G05D 1/0238; G05D 1/0212; G05D 2201/0216; G06K 7/1417; G01C 21/206

(57) ABSTRACT

An automatic guided vehicle positioning system includes one or more positioning areas and an automatic guided vehicle. The positioning areas each have a positioning pattern. The automatic guided vehicle includes a beam emitter, a beam receiver, and a processor. The beam emitter is configured to emit a light beam to scan the positioning areas. The beam receiver is configured to be spaced apart from the beam emitter by a specific distance, wherein the beam receiver receives the light beam scattered by an area other than the corresponding positioning pattern of the positioning areas and does not receive the light beam retroreflected by the corresponding positioning pattern. The processor is configured to recognize the corresponding positioning pattern based on the light beam received by the beam receiver and the retroreflected light beam not received by the beam receiver and to position the automatic guided vehicle.

### BACKGROUND OF THE INVENTION

### Technical Field

The disclosure relates to an automatic guided vehicle (AGV) positioning system, and relates to an automated guided vehicle positioning system for positioning an automated guided vehicle by scanning a positioning pattern.

### Description of the Related Art

Existing automatic guided vehicle (AGV) technology has certain requirements for the environment, and the physical contour positioning method based on the environment is an existing technology that is mature. For example, a conventional automatic guided vehicle may use laser radar to detect the contours of the surrounding environment, thereby determining or positioning the automatic guided vehicle.

However, when the environments are similar (i.e., the contours of the surrounding environment of multiple positions are similar to each other), additional reflective boards or target blocks are usually added to the environment, so that similar environments may have different features and achieve recognition and positioning. Furthermore, there may be a large number of similar environments, and in addition to adding reflective boards or target blocks, there are also methods of modifying their size and contours. These methods are difficult to implement, however, and it is very difficult to reach hundreds of differences, and it is impossible to expand to thousands of differences.

### BRIEF SUMMARY OF THE INVENTION

The disclosure provides an automatic guided vehicle (AGV) positioning system. The AGV positioning system includes one or more positioning areas and an automatic guided vehicle. The positioning areas are disposed in a space, wherein each of the positioning areas has a positioning pattern. The automatic guided vehicle includes a beam emitter, a beam receiver, and a processor. The beam emitter is configured to emit a light beam to scan the positioning areas. The beam receiver is configured to be spaced apart from the beam emitter by a specific distance, wherein the beam receiver receives the light beam scattered by an area other than the corresponding positioning pattern of the positioning areas and does not receive the light beam retroreflected by the corresponding positioning pattern. The processor is configured to recognize the corresponding positioning pattern based on the scattered light beam received by the beam receiver and the retroreflected light beam not received by the beam receiver and to position the automatic guided vehicle according to the corresponding positioning pattern.

The disclosure provides an operating method of an automatic guided vehicle (AGV) positioning system. The operating method of the AGV positioning system includes disposing one or more positioning areas in a space, wherein each of the positioning areas has a positioning pattern; scanning the positioning areas using a light beam; receiving the light beam scattered by an area other than the corresponding positioning pattern of the positioning areas, and not receiving the light beam retroreflected by the corresponding positioning pattern; and recognizing the corresponding positioning pattern according to the received light beam and the unreceived retroreflected light beam and positioning an automatic guided vehicle according to the corresponding positioning pattern.

### BRIEF DESCRIPTION OF DRAWINGS

In order to describe the manner in which the above-recited features of the disclosure can be obtained, a more particular description of the principles briefly described above will be rendered by reference to specific examples thereof which are illustrated in the appended drawings. It should be understood that these drawings depict only exemplary aspects of the disclosure and are therefore not to be considered to be limiting of its scope. The principles herein are described and explained with additional specificity and detail through the use of the accompanying drawings, in which:

FIG. 1A is a partial schematic diagram of an automatic guided vehicle positioning system, in accordance with some embodiments of the disclosure.

FIG. 1B is a top view of the automatic guided vehicle positioning system, in accordance with some embodiments of the disclosure.

FIG. 1C is a schematic diagram of a positioning pattern, in accordance with some embodiments of the disclosure.

FIG. 2 is a schematic diagram of an automatic guided vehicle scanning the positioning pattern in the automatic guided vehicle positioning system, in accordance with some embodiments of the disclosure.

FIG. 3A illustrates a retroreflective principle, in accordance with some embodiments of the disclosure.

FIG. 3B is a schematic diagram of a retroreflective texture and structure, in accordance with some embodiments of the disclosure.

FIG. 4A is a schematic diagram of a detection module detecting a surface having a retroreflective texture and a non-reflective texture, in accordance with some embodiments of the disclosure.

FIG. 4B is a schematic diagram of an image obtained by the detection module scanning the surface, in accordance with some embodiments of the disclosure.

FIG. 5 is a flowchart of an operation method of the automatic guided vehicle positioning system, in accordance with some embodiments of the disclosure.

### DETAILED DESCRIPTION OF THE INVENTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at, near, or nearly at,” or “within 3-5% of,” or “within acceptable manufacturing tolerances,” or any logical combination thereof, for example.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. For example, if the device in the figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Automatic guided vehicle may scan a contour of surrounding environment and establish a map for positioning. This technique may be called as simultaneous localization and mapping (SLAM). For example, the automated guided vehicle may scan environment contours in a space (e.g., a warehouse) by using suitable light beams such as lasers and infrared radiations during operation, and establish a map of the space to position the automated guided vehicle in the space.

However, there may be many areas with the similar environments in the space. For example, as objects (e.g., goods) are stacked in the space, multiple walkways or intersections in the space will be similar to each other. When the automated guided vehicle passes these areas with the similar environments, the automated guided vehicle may lose navigation, which lead to misjudgment of correct position of the automated guided vehicle on the map.

Therefore, mark objects (e.g., reflective boards, target blocks, etc.) may be additionally disposed in these areas with the similar environments, so that the environments of these areas have environmental differences. In generally, the number, size, shape and contour of the mark objects may be designed to increase the number of the environmental differences. However, with the increase of the space, the number of the areas with the similar environments also increases, the number of the environmental differences caused by designing the mark objects may no longer be sufficient. In addition, manufacturing different numbers, sizes, and shapes of the mark objects also requires higher costs.

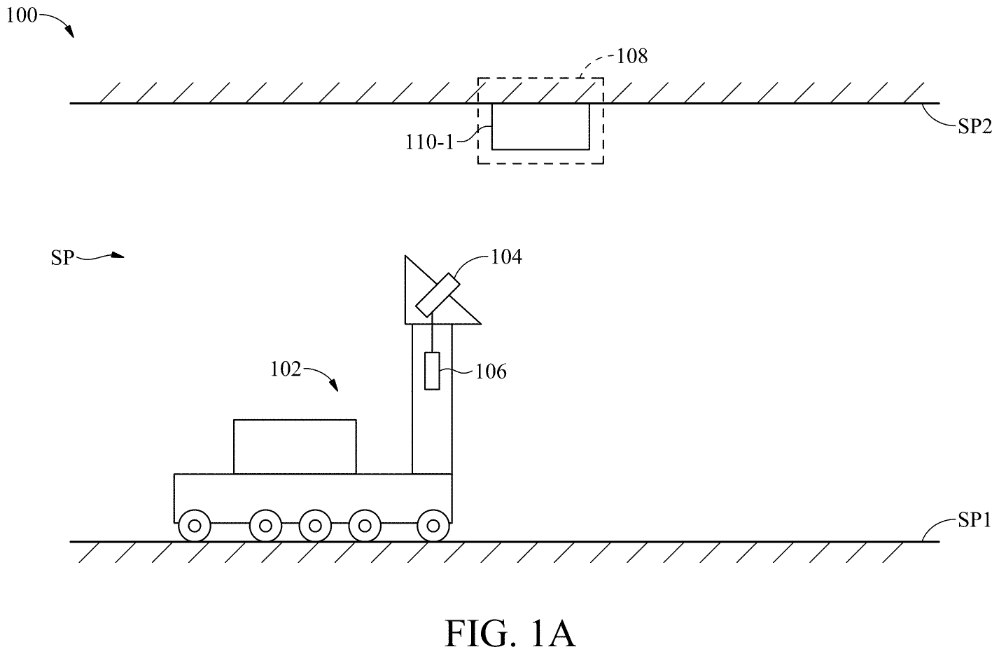

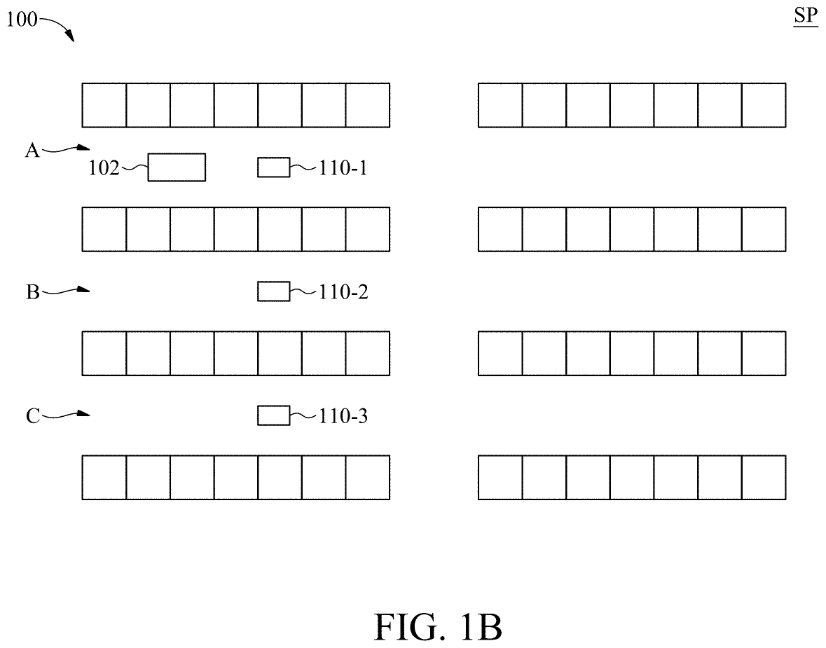

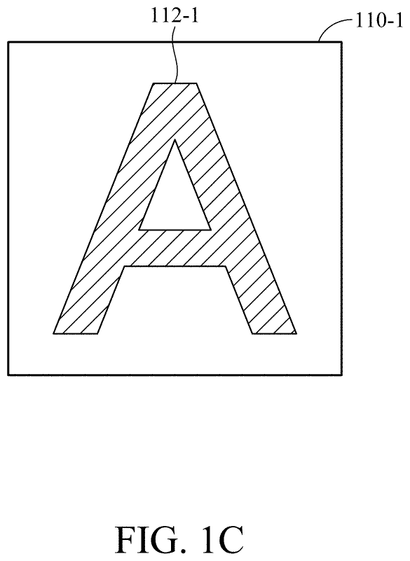

FIG. 1A is a partial schematic diagram of an automatic guided vehicle positioning system, in accordance with some embodiments of the present disclosure. FIG. 1B is a top view of the automatic guided vehicle positioning system, in accordance with some embodiments of the present disclosure. Automatic guided vehicle positioning system 100 includes an automatic guided vehicle 102. The automatic guided vehicle 102 is disposed on floor SP1 of space SP, and is movable along the floor SP1. The automatic guided vehicle 102 includes a detection module 104 and a processor 106. As described above, the automatic guided vehicle 102 may detect (scan) the environment contours of the space SP by the detection module 104 to establish a map of the space SP for positioning.

The automated guided vehicle 102 may carry one or more goods, and the automated guided vehicle 102 may include other devices or components, such as a display, an anti-collision sensor or another component of the automated guided vehicle, or a combination thereof.

The detection module 104 may be a suitable device that can detect the contour of the environment, such as a depth camera, a contour scanner, a laser rangefinder, and a laser radar, etc. The detection module 104 may have a beam emitter (not shown) and a beam receiver (not shown), so as to emit a light beam to surrounding environment by the beam emitter (scanning the surrounding environment by using the light beam) and receive the light beam reflected (scattered) by the surrounding environment by the beam receiver, so that the processor 106 may obtain the contour of the surrounding environment and establish a map of the space SP to position the automatic guided vehicle 102 according to the received light beam. The beam emitter may emit a light beam, such as a laser beam, an infrared beam, or another beam that is suitable for scanning the surrounding environment. The beam receiver may receive the reflected laser beam, infrared beam, or other suitable beam emitted by the beam emitter for scanning the surrounding environment.

The processor 106 may be a completely self-contained computing system, containing single core processor or multiple cores processor, a bus, memory controller, cache, etc. A multi-core processor may be symmetric or asymmetric. The processing unit 202 can be used to perform image process to the teeth image. In the one embodiment, the processor 106 may perform calculation, determination, and simulation according to the light beam received by the beam receiver.

In some embodiments, the processor 106 may be independent of the automated guided vehicle 102 (i.e., the processor 106 is in an external device (e.g., a computer)), and the automated guided vehicle 102 may include a transmission device (e.g., a wireless transmission device) to transmit the result of the light beam received by the beam receiver to the processor 106 for calculation, determination, and simulation.

If the space SP has many areas with similar environments (e.g., positions A, B, and C in FIG. 1B have similar environments), the mark objects may be additionally disposed in these areas to make environmental differences. For example, FIG. 1A may also be a schematic diagram corresponding to the position A of FIG. 1B. In FIG. 1A, a positioning area 108 is disposed on a ceiling SP2 of the space SP, and the positioning area 108 has one or more mark objects 110-1 (e.g., one mark object 110-1 as shown in FIG. 1A), making the area of this space SP different from other areas with similar environment (e.g., the positions B and C individually have mark objects 110-2, 110-3 that are different in number, shape, or size from mark object 110-1) (i.e., the contour of the ceiling SP2 is changed). The mark object 110-1 may be disposed elsewhere (e.g., a wall or a shelf of the space SP). In one embodiment, the mark object 110-1 is disposed on the ceiling SP2, so that the mark object 110-1 is less likely to occupy the floor space of the space SP or less affected by the stacking of the goods (e.g., being blocked by the goods).

As described above, if the space SP has more areas with similar environments, the number of the environmental differences caused by the mark objects disposed in these areas may not be sufficient, and the manufacturing cost is increased. Therefore, in the embodiment, the lower surface of the mark object may have a positioning pattern to further form an environmental difference in the similar environments. FIG. 1C is a schematic diagram of a positioning pattern, in accordance with some embodiments of the disclosure. The lower surface of the mark object 110-1 (the surface facing the floor SP1) has a positioning pattern 112-1. The automatic guided vehicle 102 may scan the positioning pattern 112-1 by the detection module 104, so that the processor 106 may recognize the positioning pattern 112-1 to position the automatic guided vehicle 102. For example, the positioning pattern 112-1 is “A”, after the detection module 104 scans the positioning pattern 112-1, the processor 106 recognizes that the positioning pattern 112-1 is “A”, and it may obtain that the automatic guided vehicle 102 is at the position A of the space SP.

Similarly, the positioning pattern (not shown) of the mark object 110-2 at the position B and the positioning pattern (not shown) of the mark object 110-3 at the position C may be “B” and “C”, respectively. When the automatic guided vehicle 102 passes the position B or the position C, the position (or coordinate) of the automatic guided vehicle 102 in the space SP may be positioned by recognizing the corresponding positioning pattern.

In some embodiments, in the space SP, the mark object may be omitted, and different positioning patterns are individually disposed in areas with similar environments to make the environmental differences. For example, the mark objects 110-1 to 110-3 in FIG. 1B may be omitted, and different positioning patterns can be directly disposed on the corresponding positioning areas (e.g., the positioning area 108 of the position A) of the ceiling SP2 of the positions A, B, and C. In this way, the cost of manufacturing the mark objects can be reduced.

The positioning pattern may be various characters, symbols, numbers, or other geometric patterns. The positioning pattern may be a flat object. One side of the positioning pattern is made of a retroreflective texture, and the other side is adhesive. Therefore, the positioning pattern may be easily manufactured and easily disposed in any area, and a plurality of differences may be made to distinguish between similar environments in space.

The automatic guided vehicle 102 further includes a storage device (not shown), the storage device has a coordinate lookup table corresponding to the positioning pattern. After the processor recognizes the corresponding positioning pattern, the coordinated lookup table may be used to position the automatic guided vehicle 102. The coordinate lookup table has been recorded and stored in storage devices in advance, including the positioning patterns or a SLAM map. In one embodiment, the corresponding positioning pattern 112-1 at the position A in FIG. 1B may be a regular triangle pattern, and the coordinate lookup table in the storage device of the automatic guided vehicle 102 has coordinate information of the space SP corresponding to the regular triangle pattern. After the automatic guided vehicle 102 passes the position A and scans the positioning pattern 112-1 to recognize the regular triangle pattern, the coordinate lookup table may be used to obtain the coordinate information of the space SP corresponding to the regular triangle pattern, thereby positioning the automatic guided vehicle 102.

In other embodiments, the positioning pattern may be a QR code, and the QR code has coordinate information or positioning information related to the space SP. For example, the coordinate information or positioning information of the positions A, B, and C in the space SP in FIG. 1B is encoded into a QR code, and the pattern of the QR code is used as a positioning pattern. When the automatic guided vehicle passes the positions A, B or C, the corresponding QR code may be scanned and decoded to obtain the corresponding coordinate information or positioning information.

The technique of scanning the positioning pattern by the automatic guided vehicle will be described below.

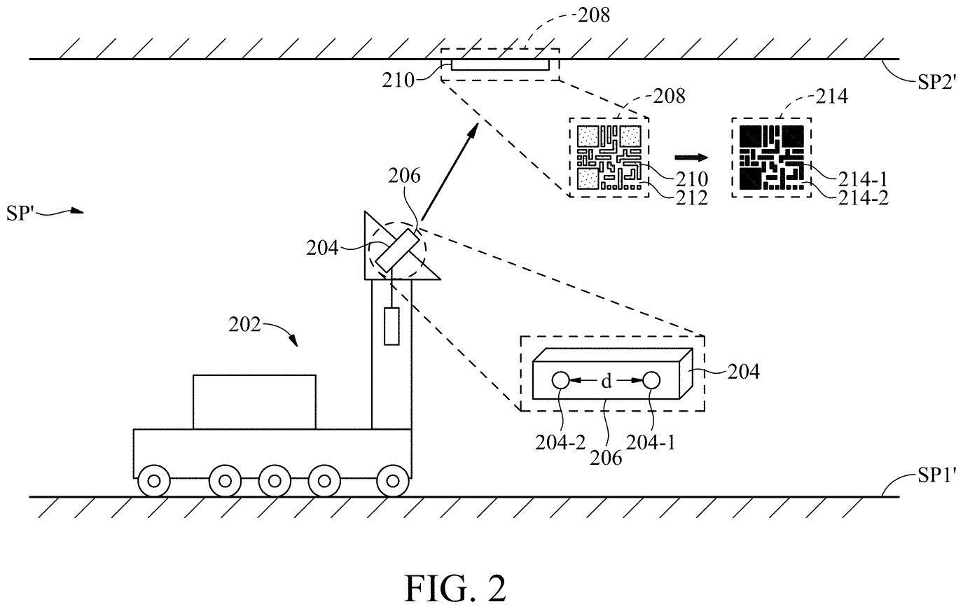

FIG. 2 is a schematic diagram of an automatic guided vehicle scanning the positioning pattern in the automatic guided vehicle positioning system, in accordance with some embodiments of the disclosure. An automatic guided vehicle 202 is in the space SP′, and a positioning area 208 is disposed on ceiling SP2′ of space SP′. The positioning area 208 has a positioning pattern 210. As described above, one side of the positioning pattern is made of a retroreflective texture (this side faces floor SP1′). Therefore, the positioning pattern 210 in the positioning area 208 may also be referred to as a retroreflective area, and the area other than the positioning pattern 210 in the positioning region 208 may be referred to as a non-retroreflective area 212. The automatic guided vehicle 202 further includes a detection module 204, and a surface 206 of the detection module 204 includes a beam emitter 204-1 and a beam receiver 204-2. The beam emitter 204-1 and the beam receiver 204-2 are separated from each other by a specific distance d. The specific distance d is within a range in which the beam receiver 204-2 may receive a reflected or scattered light beam (emitted by the beam emitter 204-1), and outside a range in which the beam receiver 204-2 receives a retroreflected beam. Similarly, the positioning area 208 (the positioning pattern 210) may be disposed elsewhere.

As shown in FIG. 2, the automatic guided vehicle 202 scans the positioning area 208 (shown by an arrow) by the beam emitter 204-1 to detect and recognize the positioning pattern 210. After the light beam emitted by the beam emitter 204-1 reaches the positioning area 208, the positioning pattern 210 reflects the light beam in the opposite direction of incident direction of the light beam, and the non-retroreflective area 212 scatters the light beam in all directions. Since the beam emitter 204-1 and the beam receiver 204-2 are separated from each other by the specific distance d, the light beam reflected by the positioning pattern 210 will be reflected back to the beam emitter 204-1 without being reflected to the beam receiver 204-2, and the beam receiver 204-2 receives the light scattered by the non-retroreflective area 212. In other words, the beam receiver 204-2 may receive light beams scattered by the area other than the positioning pattern 210 (e.g., the non-retroreflective area 212). Therefore, the detection module 204 may obtain an image 214. The image 214 includes a dark area 214-1 and a bright area 214-2. The dark area 214-1 is caused by the light beam that is not reflected back to the beam receiver 204-2 (i.e., the light beam reflected by the positioning pattern 210), the bright area 214-2 is caused by the light scattered by the non-retroreflective area 212 (the light actually received by the beam receiver 204-2). In this way, the processor of the automatic guided vehicle 202 may recognize the positioning pattern 210 according to the dark area 214-1 and the bright area 214-2 (i.e., the received light beam) of the image 214.

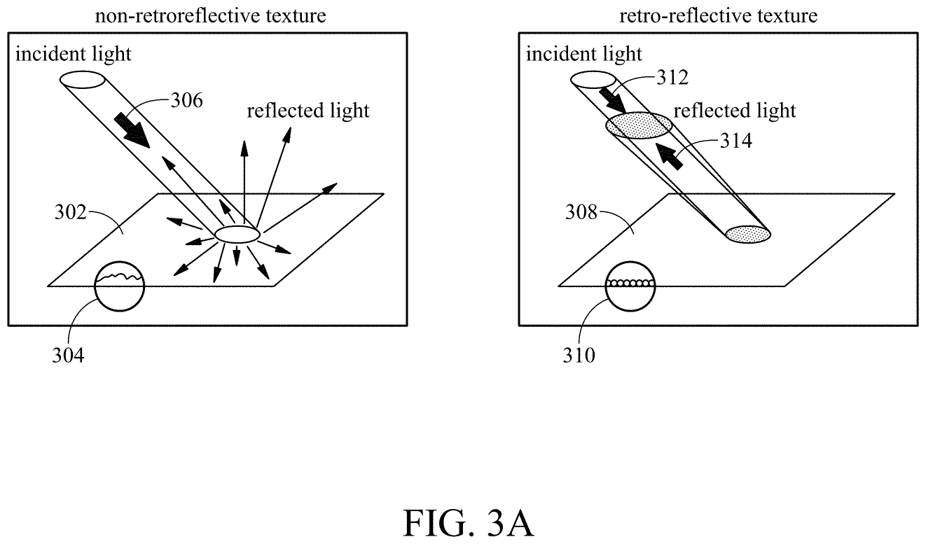

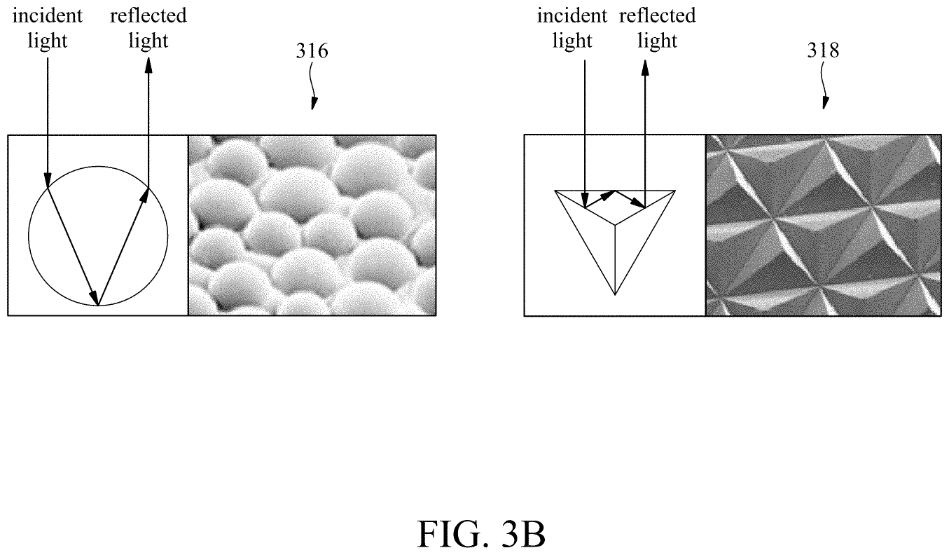

FIG. 3A illustrates a retroreflective principle, in accordance with some embodiments of the disclosure. The non-retroreflective texture 302 has a rough surface 304. When an incident light reaches the non-retroreflective texture 302 along a direction 306, the reflected light will be scattered (diffuse) to surrounding environment. Non-retroreflective textures may be paper, cloth, cement, tile, plastic, general materials or another material that will not retroreflect light. The retro-reflective texture 308 has a retro-reflective surface 310 made of a retro-reflective material. When the incident light reaches the retroreflective texture 308 in a direction 312, the reflected light will retro-reflect in direction 314, which is the opposite of direction 312. The retroreflective materials may be materials with special structures, such as glass, acrylic, or another material that refracts light beams. In the above embodiment, the mark objects 110-1 to 110-3, and the ceilings SP1 and SP1′ may be made of a non-retroreflective texture. In some embodiments, the non-retroreflective texture and the retroreflective texture together form a planar object, and the part of the retroreflective texture serves as a positioning pattern.

As shown in FIG. 3B, retroreflective structure of the retroreflective material may be a round ball structure 316, a prism structure 318, or another structure that can reflect the incident light in the opposite direction of the incident direction of the incident light (multiple reflections and/or refractions may occur in the structure).

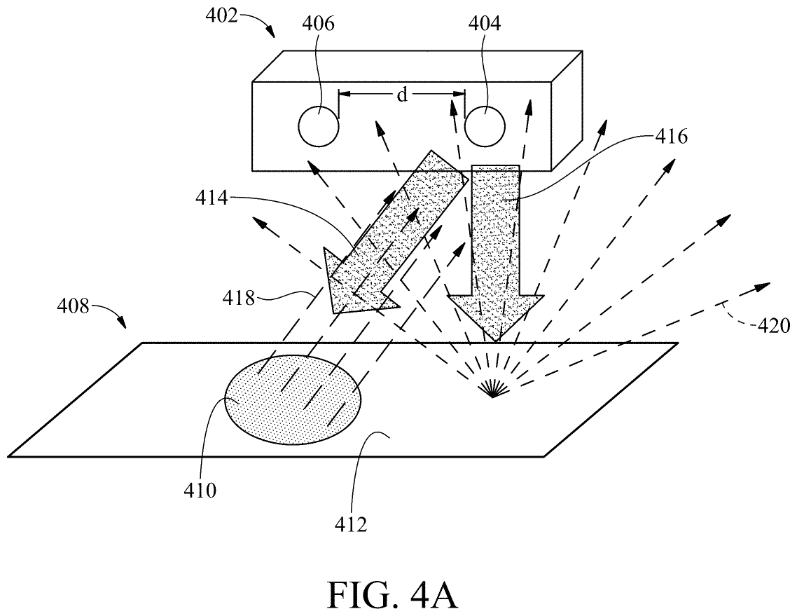

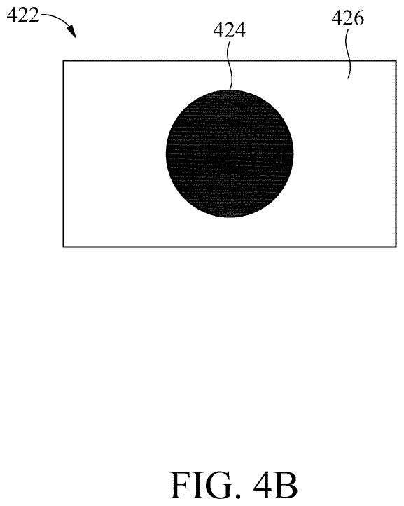

FIG. 4A is a schematic diagram of a detection module detecting a surface having a retroreflective texture and a non-reflective texture, in accordance with some embodiments of the disclosure. The detection module 402 has a beam emitter 404 and a beam receiver 406, wherein the beam emitter 404 and the beam receiver 406 are separated from each other by a specific distance d. The beam emitter 404 emits a light beam to scan a surface 408 having a retro-reflective area 410 and a non-retroreflective area 412. In one embodiment, a direction 414 is taken as an example of the direction of the light beam to the retroreflective area 410, and a direction 416 is taken as an example of the direction of the light beam to the non-retroreflective area 412. The retroreflective area 410 is made of a retroreflective texture, and the non-retroreflective area 412 is made of a non-retroreflective texture. As described above, the light beam emitted to the retro-reflective area 410 is retro-reflected back to the beam emitter 404 (in direction 418, which is the opposite of direction 414), and the light beam emitted to the non-retroreflective area 412 is scattered (in multiple directions 420). Since the beam emitter 404 and the beam receiver 406 are separated by the specific distance d, the light beam reflected by the retro-retroreflective area 410 is not received by the beam receiver 406, and a part of the light beam scattered by the non-retroreflective area 412 is received by the beam receiver 406. In other words, the beam receiver 204-2 may receive a light beam scattered by an area other than the retro-reflective area 410 (non-retroreflective area 412). In addition, the specific distance d is designed so that the beam receiver 406 does not receive the light beam reflected by the retro-reflective area 410.

FIG. 4B is a schematic diagram of an image obtained by the detection module scanning the surface, in accordance with some embodiments of the disclosure. The detection module 402 scans the surface 408 to obtain an image 422. As described above, since the beam receiver 406 does not receive the light beam reflected by the retro-reflective area 410, the image 422 obtained by the detection module 402 has a dark area 424, and the light beam scattered by the non-retroreflective area 412 to the beam receiver 406 forms a bright area 426 in the image 422. The processor of the automatic guided vehicle may recognize the pattern formed by the dark area 424 and the bright area 426 (i.e., the light beam received by the beam receiver 406) of the image 422.

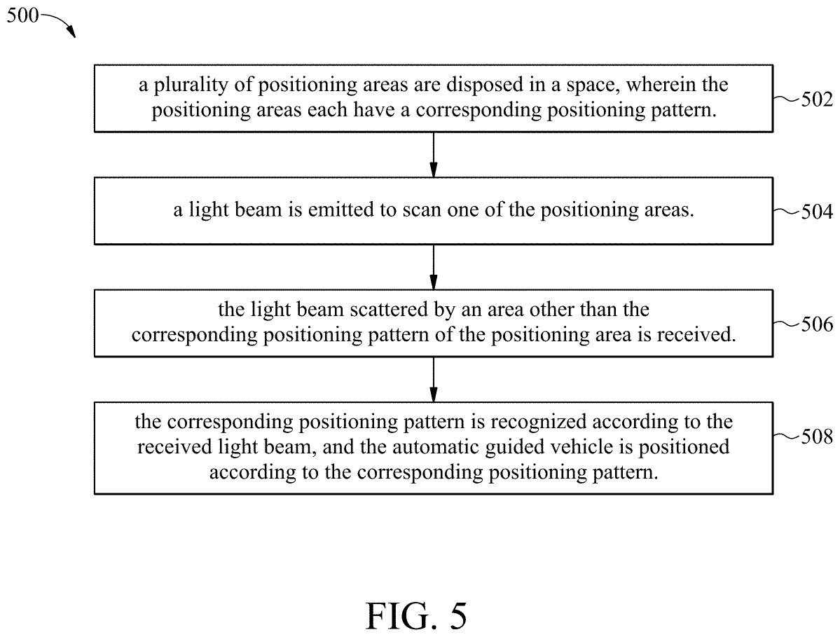

With reference to the embodiments and descriptions in FIGS. 3A to 4B, it is understand the principle of the automatic guided vehicle of FIGS. 1 and 2 scanning and recognizing the positioning pattern. FIG. 5 is a flowchart of an operation method 500 of the automatic guided vehicle positioning system of FIGS. 1 and 2, in accordance with some embodiments of the present disclosure. In operation 502, a plurality of positioning areas are disposed in a space, wherein the positioning areas each have a corresponding positioning pattern.

In operation 504, a light beam is emitted to scan one of the positioning areas. For example, the beam emitter 204-1 of the detection module 204 of the automatic guided vehicle 202 emits a light beam to scan the positioning area 208.

In operation 506, the light beam scattered by an area other than the corresponding positioning pattern of the positioning area is received. For example, the beam receiver 204-2 receives the light beam (emitted by the beam emitter 204-1) scattered by an area other than the positioning pattern 210 of the positioning region 208 (such as the non-retroreflective area 212).

In operation 508, the corresponding positioning pattern is recognized according to the received light beam, and the automatic guided vehicle is positioned according to the corresponding positioning pattern. For example, the automatic guided vehicle 202 recognizes the positioning pattern 210 according to the received light beam (the image formed by the light beam scattered by an area other than the positioning pattern 210), and positions the automatic guided vehicle 202 according to the positioning pattern 210. The automatic guided vehicle 202 may recognize the positioning pattern 210 and decode the coordinate information of the positioning pattern 210 relates to the space SP′ to position the automatic guided vehicle 202. Alternatively, the automatic guided vehicle 202 includes a storage device having a coordinate lookup table corresponding to the positioning pattern. After the automatic guided vehicle 202 recognizes the corresponding positioning pattern, the coordinate lookup table may be used to position the automatic guided vehicle 202.

In the conventional automatic guided vehicle positioning system, the automatic guided vehicle uses the detection module (such as the laser radar) to scan the surrounding environment to position the automatic guided vehicle, and by mark objects (reflective boards, target blocks) to make differences in similar environments in the space to prevent the automated guided vehicle from getting lost. However, manufacturing marked objects costs many costs, and it is difficult to make multiple differences to distinguish similar environments to prevent the automated guided vehicle from getting lost.

By using the embodiments of the disclosure, it may easily manufacture positioning patterns having more than thousand kinds of differences to make differences in the space with more similar environments. In addition, the positioning pattern is made of retro-reflective texture, by using the beam emitter and the beam receiver separated by the specific distance, the automatic guided vehicle may quickly and efficiently obtain the image of the positioning pattern to recognize the positioning pattern for positioning the automatic guided vehicle.

In addition, the embodiments of the disclosure may avoid the influence of external ambient light that occurred in the conventional image recognition technology. The conventional image recognition technology obtains an image by receiving the reflected external ambient light (such as visible light) reflected by an object. Therefore, the image is susceptible to variation of external ambient light and is difficult to obtain. In contrast, the embodiments of the disclosure use the beam emitter to emit a specific type of light beam (laser, infrared light, etc.), and uses the beam receiver to receive the reflected specific type of light beam, so it is not affected by the external ambient light. In some embodiments, the automatic guided vehicle positioning system according to the embodiments of the present disclosure may operate in a dark environment while still positioning the automatic guided vehicle.

The terminology used herein is for the purpose of describing particular embodiments, and is not intended to be limiting of the invention. As used herein, the singular forms “a”, “an” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore terms, such as those defined in commonly used dictionaries, should be interpreted as having a meaning that is consistent with their meaning in the context of the relevant art, and will not be interpreted in an idealized or overly formal sense unless expressly so defined herein.

The foregoing outlines features of several embodiments so that those skilled in the art may better understand the aspects of the invention. Those skilled in the art should appreciate that they may readily use the invention as a basis for designing or modifying other processes and structures for carrying out the same purposes and/or achieving the same advantages of the embodiments introduced herein. Those skilled in the art should also realize that such equivalent constructions do not depart from the spirit and scope of the invention, and that they may make various changes, substitutions, and alterations herein without departing from the spirit and scope of the invention.

What is claimed is:

1. An automatic guided vehicle (AGV) positioning system, comprising:
one or more positioning areas, disposed in a space, wherein each of the positioning areas has a positioning pattern; and
an automatic guided vehicle, comprising:
a beam emitter, configured to emit a light beam to scan the positioning areas;
a beam receiver, configured to be spaced apart from the beam emitter by a specific distance, wherein the beam receiver receives the light beam scattered by an area other than the corresponding positioning pattern of the positioning areas and does not receive the light beam retroreflected by the corresponding positioning pattern; and
a processor, configured to recognize the corresponding positioning pattern based on the scattered light beam received by the beam receiver and the retroreflected light beam not received by the beam receiver and to position the automatic guided vehicle according to the corresponding positioning pattern.

2. The AGV positioning system as claimed in claim 1, wherein the positioning pattern has a retro-reflective structure, so that the positioning pattern reflects the light beam in an opposite direction of an incident direction of the light beam.

3. The AGV positioning system as claimed in claim 2, wherein a retro-reflective material of the retro-reflective structure is glass or acrylic material, and the retroreflective structure comprises a round ball structure or a prism structure.

4. The AGV positioning system as claimed in claim 2, wherein a texture of the area other than the corresponding positioning pattern of the positioning areas is a non-retroreflective texture, the non-retroreflective texture is paper, cloth, cement, tile, plastic, or another material that does not retroflect light.

5. The AGV positioning system as claimed in claim 1, wherein the positioning pattern is a QR code having coordinate information related to the space.

6. The AGV positioning system as claimed in claim 1, wherein the positioning areas are disposed on a ceiling, a wall, or a shelf of the space.

7. The AGV positioning system as claimed in claim 1, wherein the automatic guided vehicle further comprises:
a storage device, having a coordinate lookup table corresponding to the positioning pattern, wherein the processor uses the coordinate lookup table to position the automatic guided vehicle after the processor recognizes the corresponding positioning pattern.

8. An operating method of an automatic guided vehicle (AGV) positioning system, comprising:
disposing one or more positioning areas in a space, wherein each of the positioning areas has a positioning pattern;
scanning the positioning areas using a light beam;
receiving the light beam scattered by an area other than the corresponding positioning pattern of the positioning areas, and not receiving the light beam retroreflected by the corresponding positioning pattern; and
recognizing the corresponding positioning pattern according to the received light beam and the unreceived retroreflected light beam and positioning an automatic guided vehicle according to the corresponding positioning pattern.

9. The operating method of the AGV positioning system as claimed in claim 8, wherein the positioning pattern has a retroreflective structure.

10. The operating method of the AGV positioning system as claimed in claim 8, wherein the positioning pattern is a QR code having coordinate information related to the space.

11. The operating method of the AGV positioning system as claimed in claim 8, wherein the positioning areas are disposed on a ceiling, a wall, or a shelf of the space.

12. The operating method of the AGV positioning system as claimed in claim 8, further comprising:
using a coordinate lookup table to position the automatic guided vehicle after recognizing the corresponding positioning pattern.
